(19) United States
(12) Patent Application Publication
(10) Pub. No.: US 2004/0162127 A1
(43) Pub. Date: Aug. 19, 2004

(54) Electronic game with spinning and electronic display features

(76) Inventors: Mark Siegel, Fort Worth, TX (US); Steve Bristow, Los Altos, CA (US)

Correspondence Address: Bell, Boyd & Lloyd LLC, P.O. Box 1135, Chicago, IL, 60690-1135, US

(21) Appl. No.: 10/777,939

(22) Filed: Feb. 11, 2004

Related U.S. Application Data
(60) Provisional application No. 60/446,550, filed on Feb. 12, 2003.

(51) Int. Cl. G06F 19/00

(52) U.S. Cl. 463/9

(57) ABSTRACT

An electronic game, including a base, and a spinning unit affixed to the base and adapted to spin relative thereto. The spinning unit includes a display mechanism adapted to displaying text that dictates actions to be taken in the electronic game. The electronic game also includes a circuit for controlling the display mechanism, and a sensor including a magnet disposed in the base and a magnetic switch disposed in the spinning unit for communicating with the circuit. Whereby the circuit triggers the display mechanism based on the communications from the sensor independent of a minimum speed requirement.

### CROSS REFERENCE TO RELATED APPLICATIONS

The present invention claims the benefit of priority under 35 U.S.C. § 119(e) to U.S. Provisional Patent Application No. 60/446,550 of Mark Siegel et al., entitled “ELECTRONIC GAME WITH SPINNING AND ELECTRONIC DISPLAY FEATURES,” filed on Feb. 12, 2003, the entire contents of which is incorporated by reference herein.

### BACKGROUND OF THE INVENTION

The present invention relates to an electronic game that once spun provides an illuminated text display. More specifically, the present invention relates to an electronic game that displays a dot matrix message via a single line of LEDs upon rotation of the game. The game compensates for fluctuations in rotational speed to provide an undistorted synchronized display.

Conventional rotation games which display text typically require a minimum speed of rotation and generally fail to compensate for changes in rotational speed such that the display becomes distorted; e.g. as the speed of rotation slows down.

For example, U.S. Pat. No. 5,791,966 to Capps et al., the subject matter of which is hereby incorporated by reference, discloses a rotational toy that includes a single spinning body 103 and a row of seven LEDs 107 for displaying a message. The display is initiated when a switch 147 is actuated to provide power to the circuitry of the toy. Specifically, as the body 103 rotates, centrifugal force counteracts the force of a spring 155 of switch 147 and permits the end of the spring to swing out against a contact 159. When this occurs, the circuit is completed and the microcontroller displays the message. Thus, a minimum speed of rotation is required to create the centrifugal force such that spring 155 engages contact 159 in order to display text.

Some conventional spinning devices have used reed-switches to synchronize a text display, and therefore properly display text at various rotational velocities. However, these devices generally use a centrifugal force switch to activate the display at a minimum rotational speed.

### SUMMARY OF THE INVENTION

Accordingly, an object of the present invention is to provide an electronic game that can be spun to provide an illuminated display of text.

Another object of the present invention is to provide an electronic game that compensates for fluctuations in rotational speed to provide an undistorted and synchronized display.

Yet another object of the present invention is to provide an electronic game that provides an illuminated display upon any movement of the game without the requirement of a minimum rotational speed.

The objects of the present invention are obtained by an electronic game, including a base, a spinning unit affixed to the base and adapted to spin relative thereto, the spinning unit including a display mechanism adapted to displaying text that dictates actions to be taken in the electronic game, a circuit for controlling the display mechanism, and a sensor including a magnet disposed in the base and a magnetic switch disposed in the spinning unit for communicating with the circuit, whereby the circuit triggers the display mechanism based on the communications from the sensor independent of a minimum speed requirement.

The objects of the present invention are further obtained by a method of displaying text for an electronic gaming device, the gaming device having a spinning unit and a base, the method including the steps of rotating the spinning unit relative to the base, using a sensor to generate information by determining when the spinning unit makes a complete revolution, and the rate at which the spinning unit revolves; and initiating a text display based on the information from the sensor.

Other objects, advantages and salient features of the invention will become apparent from the following detailed description, which, taken in conjunction with annexed drawings, discloses a preferred embodiment of the present invention.

### BRIEF DESCRIPTION OF THE FIGURES

Referring to the drawings which form a part of this disclosure:

FIG. 1 is a top perspective view of the electronic game in accordance with a preferred embodiment of the present invention.

FIG. 2 is a top plan view of the electronic game illustrated in FIG. 1 with game chips inserted in the peripheral apertures.

FIG. 3 is a top plan view of the electronic game illustrated in FIG. 2 without game chips inserted in the peripheral apertures.

FIG. 4 is a side elevational view of the game illustrated in FIG. 3.

FIG. 5 is a bottom plan view of the game illustrated in FIG. 1.

FIG. 6 is a top plan view of the electronic game illustrated in FIG. 1 showing the electronic display “FORTUNE TELLER”.

FIG. 7 is a top plan view of the electronic game illustrated in FIG. 1 showing the electronic display “DOUBLE DARE”.

FIG. 8 is a top plan view of the electronic game illustrated in FIG. 1 showing the electronic display of an arrow.

FIG. 9 is a top plan view of the electronic game illustrated in FIG. 1 showing the electronic display “GIVE OR TAKE”.

FIG. 10 is a top plan view of the electronic game illustrated in FIG. 1 showing the electronic display “ORANGE”.

FIG. 11 is a plan view of the electronic game illustrated in FIG. 1, showing the spin activation sensor arrangement.

FIGS. 12-15 are a flow chart of the general game play of the electronic game in accordance with a preferred embodiment of the present invention.

### DETAILED DESCRIPTION OF THE INVENTION

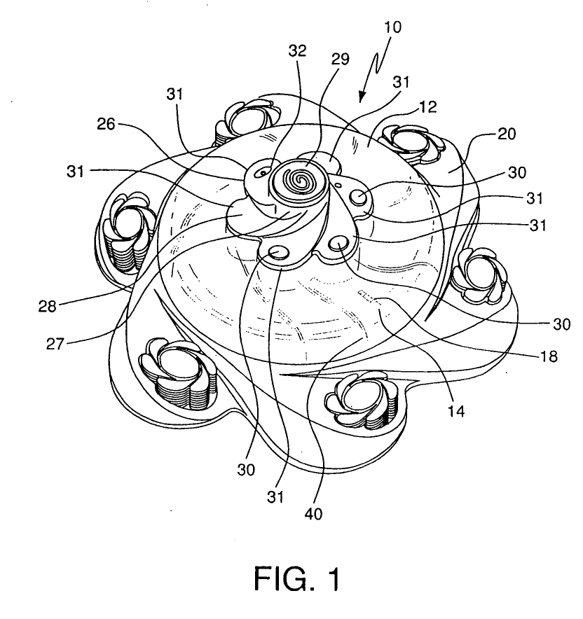

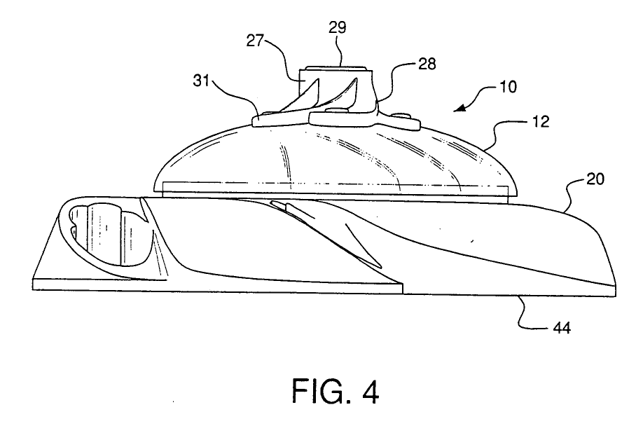

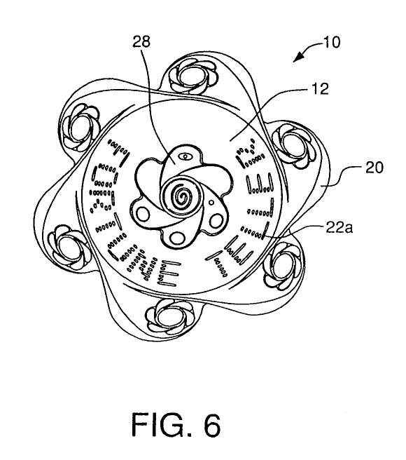

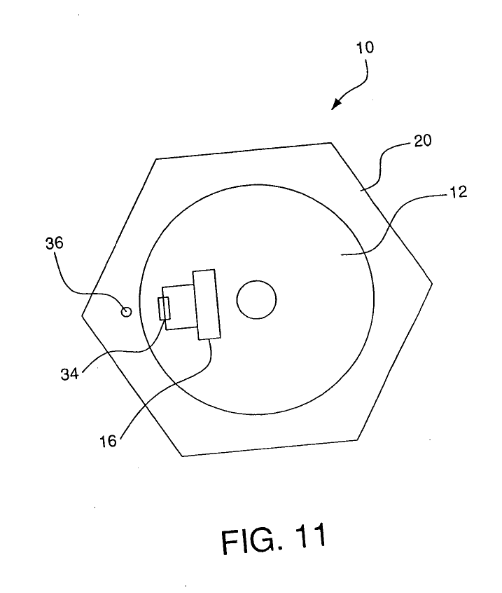

Referring to FIGS. 1-5, an electronic game 10 in accordance with an embodiment of the present invention generally includes a spinning body 12 with a display mechanism 14, preferably a row of LEDs 18, and a stationary base 20 having batteries and the associated electronics, particularly a microprocessor or a circuit 16, to produce a text display 22a-E (FIGS. 6-10) via display mechanism 14 upon rotating spinning body 12 with respect to base 20. The microprocessor 16 (FIG. 11) triggers the display 22 upon movement of spinning body 12. A minimum speed of rotation of spinning body 12 is not required for the microprocessor 16 to trigger one of the displays 22a-e (as long as the rotational speed is greater than zero). Also, the microprocessor monitors the rotational speed of spinning body 12 and mathematically corrects or compensates for any changes in the rotational speed so that the displays 22a-e and LEDs 18 remains undistorted and synchronized as body 12 rotates. Body 12 and base 20 are preferably made of an elastomer and generally form the shape of a flower. However, game 10, including body 12 and base 20, can be any desired shape or any suitable material.

Spinning body 12 is preferably made of a translucent plastic and is rotatably attached to base 20 and includes a central outwardly extending spinner handle 26 that has a handle base 28. The handle has a substantially cylindrical portion 27 that extends from the handle base 28. Handle portion 27 extends at about a 90 degree angle from base 28 and the spinning body 12. On the top surface of handle portion 27 a button 29 is disposed. This button can be for a variety of purposes, but is preferably used as a “truth detector” or “lie detector”. In other words, during game play, this button is pushed when answering a question posed, and the game determines, by random selection, if the player has told the truth to the posed question.

Handle base 28 generally surrounds portion 27 and has a variety of buttons thereon. Preferably base 28 has six areas or protrusions 31 extending outwardly from portion 27. However, the shape and configuration of base 28 can be any suitable shape or configuration desired. Additionally, base 28 does not necessarily need to have six areas or protrusions, but can have as many (or as few) portions desired.

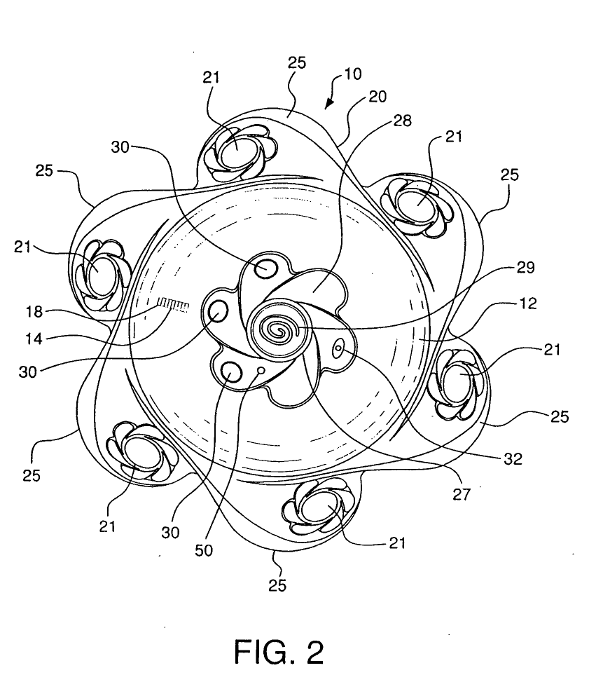

Handle base 28 supports several buttons 30 (preferably on at least three of the protrusions 31) associated with the electronics of the game, such as an “On/Mode” button, a “Play/Enter” button, a “Record” button and a “Reset” button 50 (see FIG. 2). A microphone 32 is also disposed in handle base 28 on a near buttons 30 on one of the protrusion 31 (see FIG. 2). The buttons 30, the microphone 50 the reset button do not necessarily need to be disposed on the protrusions 31, let on the handle itself and can be positioned in any suitable location.

Extending between handle base 28 and the peripheral edge 40 of body 12 is display mechanism 14 comprising a single row of seven light emitting diodes (LEDs) 18 (see FIGS. 1 and 2). However, the display mechanism can be any type of lighted display desired and does not need to be a single row of LEDs. Body 12 also includes a magnetic switch 34 for triggering the microprocessor to produce text displays 22a-e. When body 12 is spun, LEDs 18 produce a display grid. LEDs are preferably yellow-green LEDs. See FIGS. 6-10 for examples of text displays 22 associated with game 10. Note that game 10 can be programmed to display any word or phrase desired.

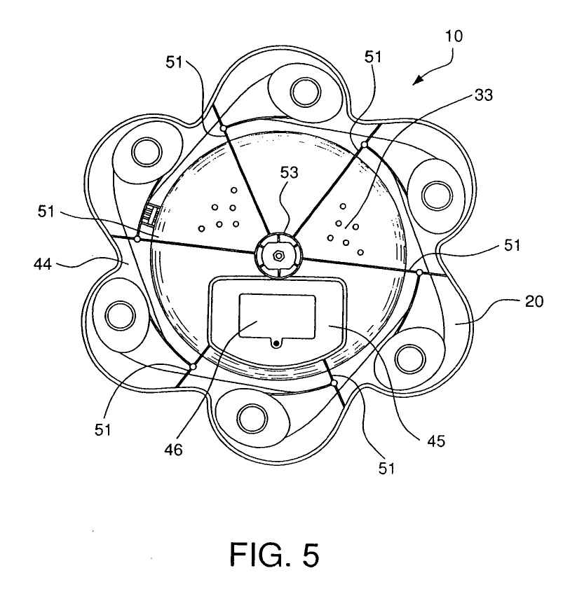

Spinning body 12 supports substantially all of the electronics associated with game 10 such as batteries, circuit board having a circuit, at least a microprocessor and a voice chip, and one or more speakers 33 (FIG. 5). As shown in FIG. 11, microprocessor or microcontroller unit (MCU) 16 is electrically coupled to the magnetic switch 34 and in communication therewith.

Microcontroller unit 16 is preferably a conventional microcontroller capable of being programmed and storing memory. Therefore, the microcontroller unit can instruct the LEDs to display stored text, instruct the speaker to transmit stored sounds and store new sounds therein. However, the microcontroller can be capable of performing any desired function, such as storing new text messages, if desired. Furthermore, the use of a microcontroller or microprocessor is not necessary and any circuit or electrical and/or mechanical components suitable (or any other suitable means) for playing any feature of this invention can be used.

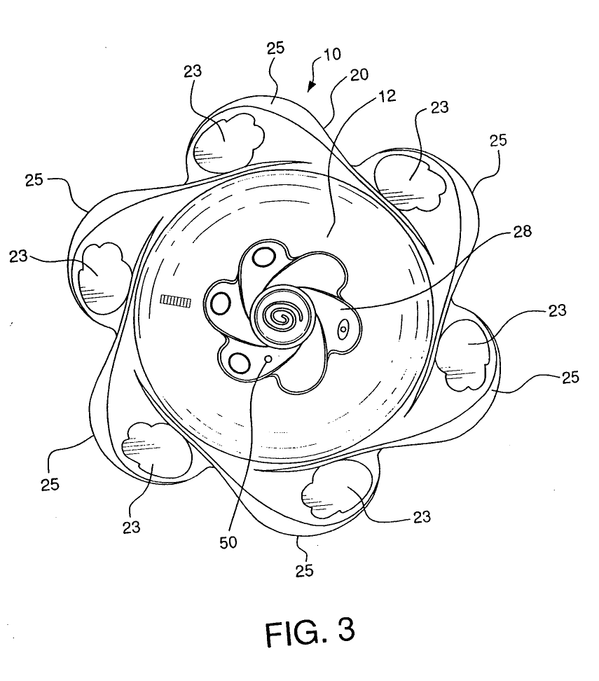

As shown in FIGS. 2 and 3, base 20 has six protrusions 25 that hold cards and/or chips 21 used for playing game 10. Chips 21 are disposed in apertures or openings 23 and are used by the game players. Once all six different types are collected, the player that has collected the chips is the winner. However, it is noted that this is only a preferred method of game play and the winner or no winner can de determined in any manner desired. Additionally the game can have cards (not shown) that are stored in the base or in another container and used to instruct the players as to the truth to tell or the dare to perform. It is noted that the base does not need to have apertures for chips, but may have slots for the cards or no slots or apertures or any combination thereof.

A magnet 36 is disposed in base 20 that cooperates with magnetic switch 34 of spinning body 12 to communicate with the microprocessor of game 10. the combination of magnet 36 and switch 34 is preferably a reed-switch or any other suitable switch or sensor that would allow the game to perform the desired text display. For example, other suitable switches can be a mechanical switch, an optical switch or any other suitable switch or sensor. Additionally, a second magnetic switch (not shown) can be disposed in the same manner as switch 34 that would allow the microprocessor to detect spin direction by leading or trailing switch 34, thus allowing a proper display regardless of spin direction.

As shown in FIG. 5, the base 20 substantially surrounds the spinning body and has a bottom surface 44 that is substantially flat and planar so as to provide a stable surface of game play. However, base 20 does not necessarily need to surround the spinning body and can have suitable configuration that would allow the present invention to work in the desired manner. For example, the base can only have one portion adjacent the spinning body, in which magnet 36 is disposed. Surface 44 has an opening therein that exposes the bottom of spinning body 12 and speaker 33. Several structural rods 51 are connected to base 20 and a center portion 53 to increase the structural integrity of the base 20. Connected to rods 21 is the battery compartment 45. Compartment 45 has a door 46 therein to access the battery or batteries in the battery compartment. However, it is noted that the game 10 can have any suitable power supply, such as a non-accessible, rechargeable battery or batteries, solar power, kinetic power or an electrical plug.

If desired some of the electronics can be disposed in the base 20 rather than in the spinning body. For example, only the magnet or the magnetic switch can be stored in the spinning body (along with the display mechanism and necessary electronics for the display mechanism), as long as the required components are in electrical communication with the microprocessor and the device operates in a suitable manner.

Furthenmore, it is noted that the game can have a reset button 50, as shown in FIGS. 2 and 3, that can reset the game. This reset preferably erases all memory and restarts the game, but can be programmed to perfonn any level of reset desired.

Operation

In general, a player spins body 12 with respect to base 20 to produce text display 22. The microprocessor turns the individual LEDs 18 on and off to produce text display 22. A spin activation sensor comprising the magnetic switch 34 of spinning body 12 and the magnet 36 of base 20 communicates to the microprocessor the number of rotations and the rotational speed of spinning body 12 with respect to base 20 to initiate a text display, such as displays 22a-e or any other suitable display. More specifically, when spinning body 12 is spun, as magnetic switch 34 of spinning body 12 passes by magnet 36 of base 20, a pulse is produced. Thus one pulse defines one full rotation of spinning body 12 with respect to body 20. Each pulse is recognized by the microprocessor, thereby communicating to the microprocessor both that spinning body 12 is rotating and the number of rotations. Additionally, using the sensor of the magnetic switch 34 and magnet 36, the microprocessor calculates the time between pulses and thus the rotational speed and any changes in the rotational speed.

The sensor comprising magnetic switch 34 and magnet 36 is used in two ways. The first way is to start the game 10 and particularly to start a text display. Microprocessor is programmed to start game 10 after any predetennined amount of pulses, e.g. 3 pulses or a low to high back to low trigger event, and a text display will be initiated. In other words, body 12 will be assumed to be spinning after some amount of these events or pulses. This pulse start routine of the microprocessor has no time restraints so that any number of pulses can start the sequence. If no more pulses are detected within a predetermined set of time after the start routine is triggered, spinning of body 12 is assumed to have ceased and the microprocessor will time out and end the display.

The second way of using the sensor is as a sync position, so that the text display remains visually in a fixed position as body 12 is spinning. A pulse produced by the magnetic switch will be the only means to trigger the starting position for outputting the text display. The microprocessor monitors timing between pulse events in order to modify the display based on rotational timing. This allows the microprocessor to correct for changes in rotational speed so that LEDs 18 are illuminated to produce text display in the same or fixed place, thereby ensuring the display is not distorted due to fluctuations in rotational speed. Some correction techniques include leaving the LEDs 18 illuminated for a shorter or longer time, or starting the illumination of the LEDs 18 sooner or later. By mathematically dividing the time period between pulses by 360, the microprocessor can determine where the LED is in its rotational travel in degrees.

Game Play

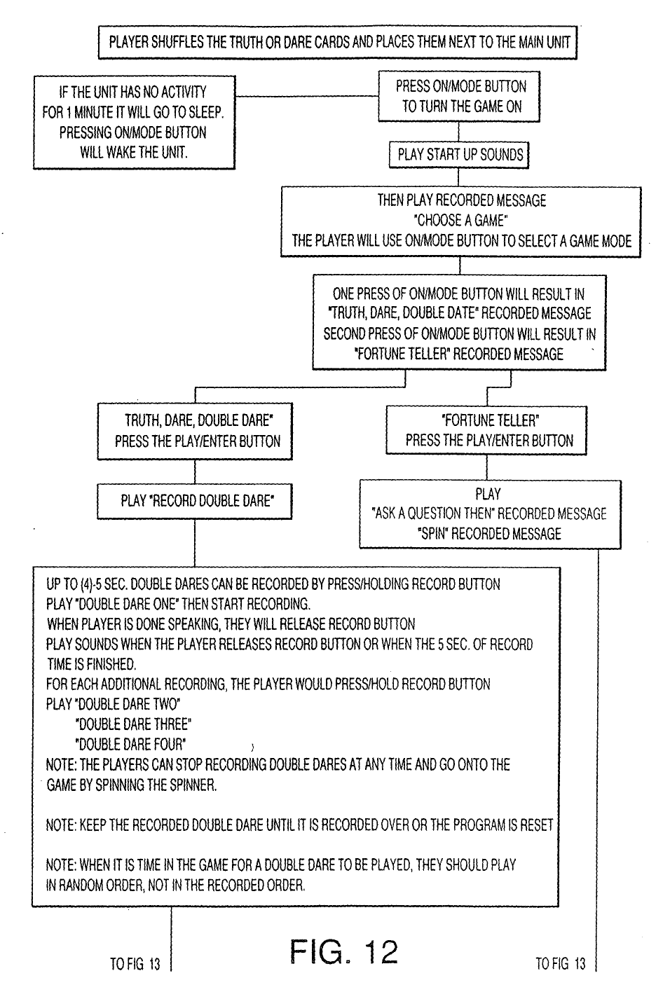

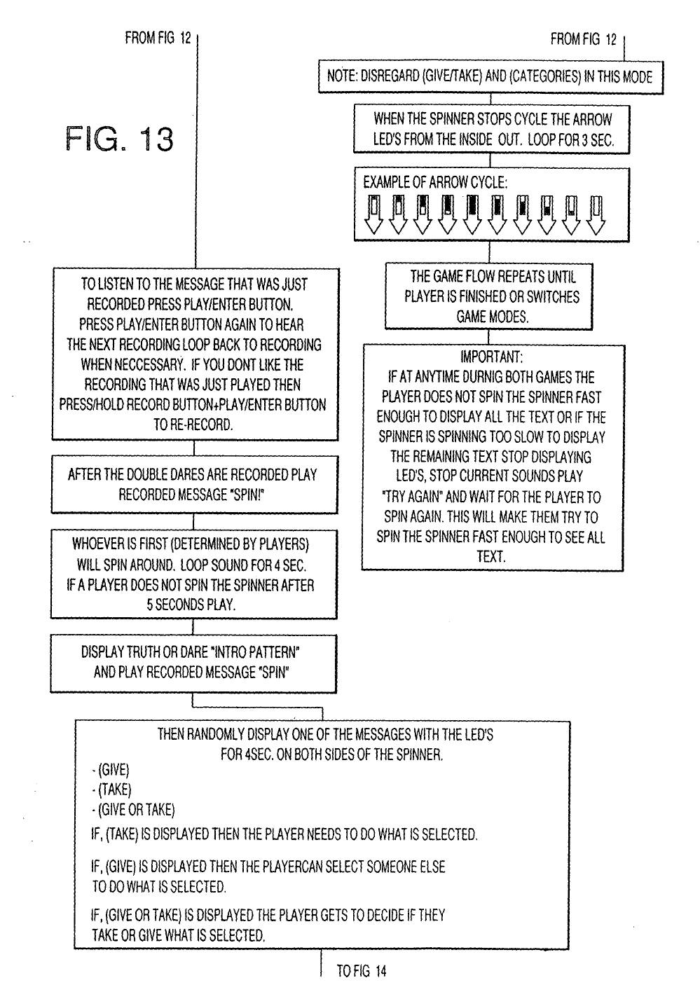

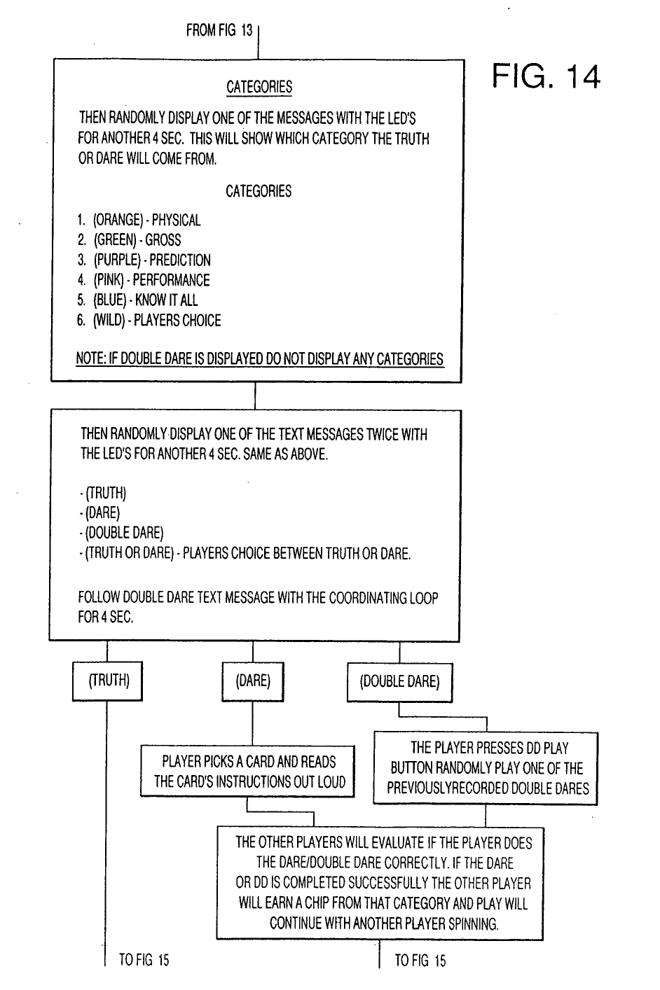

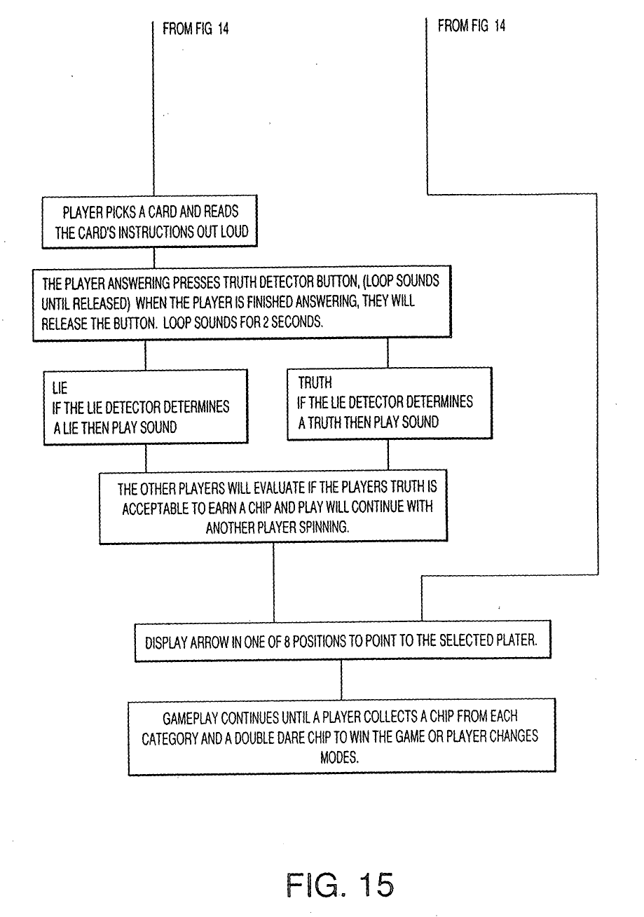

FIGS. 12-15 illustrate the preferred basic steps for playing game 10. It is noted that the game does not necessarily need to be played in the order of FIGS. 12-15 and does not necessarily need to include each of the shown steps. The game is preferably started by turning the game on by pressing the on/mode button. The game system will then request, through speaker 33 that you select a game, preferably Truth, Dare, Double Dare or Fortune Teller. Toggle through the Press/Play/Enter button to select a choice.

Assuming the game of FORTUNE TELLER is selected, the game will display “FORTUNE TELLER”, as shown in FIG. 6. The game player then asks a question, either out loud or not, and then spins the handle 26. The blue dome will display, through the text display one of following answers to your question, Definitely, You Bet, Sure, Don't Know, Whatever, Who Knows, No Way, Not likely, or Dream on. However, it is noted that these specific text messages or answers do not need to be displayed and any text desired can be displayed

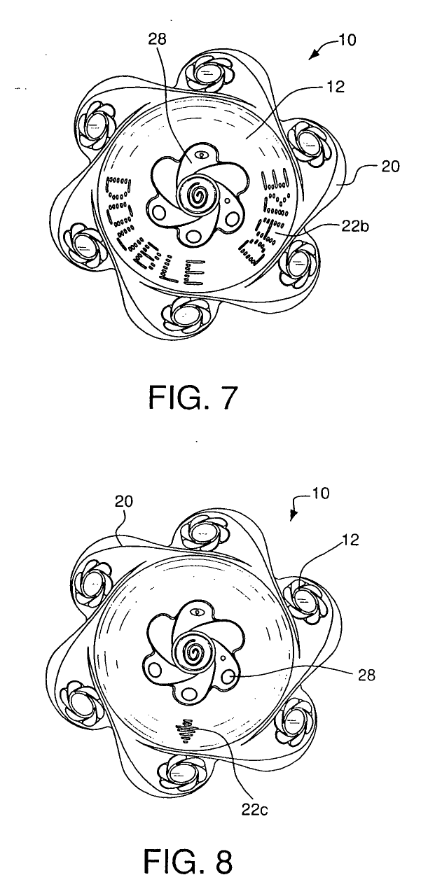

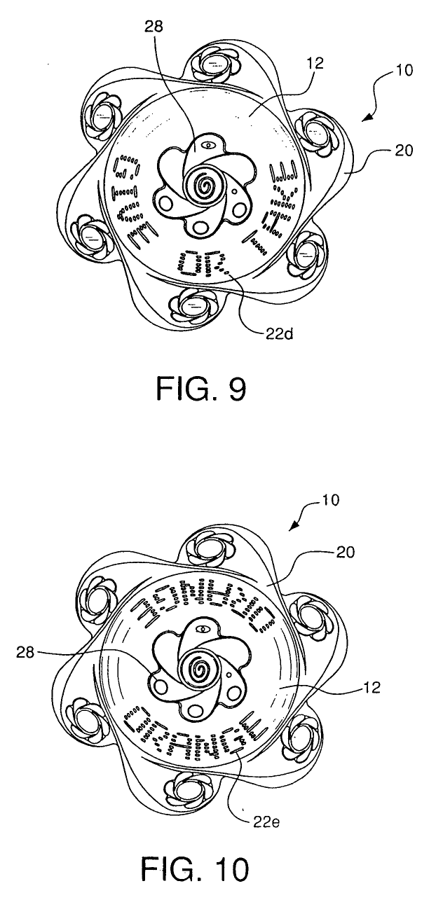

Assuming the game of TRUTH, DARE, DOUBLE DARE is selected, the game will display “DOUBLE DARE”, as shown in FIG. 7. The game will then prompt the players to record the games double dares. At this point the players can record the up to 4 double dares by pressing and holding the record button and speaking into the microphone, or the players can merely spin the handle and move to the game. Prior to spinning the handle, a player is randomly selected. This randomly selected player then spins the handle. The LED display will display a series of instructions. The first instruction is preferably give, take or give or take. The game will display one of these instructions, such as “GIVE OR TAKE”, as shown in FIG. 9. These instructions require the player selected by the game (see below) to either give, take or choose whether to give or take the dare, double dare or truth. The next instruction is preferably the category from which to select the truth or dare. For example, the categories can be truths and dares that involve physical activity or ability, truths and dares that are unpleasant or truths and dares that you would hope or dream about. The game will display one of these instructions as a color category, such as “ORANGE”, as shown in FIG. 10. The third instruction is whether the player must tell the truth, perform a dare, perform a double dare or choose between truth and dare. The game will then display one of these instructions, such as “DOUBLE DARE”, as shown in FIG. 7. The fourth and final instruction at this time is an arrow that will randomly point at a game player, as shown in FIG. 8. The arrow determines who has to give or take the truth, dare or double dare. The arrow can point in a consistent direction (i.e., at one player) as the rotating body spins.

The player at which the arrow points then must select a card or choose another player to select a card from. a specific category (depending on the instructions) and perform either the truth or dare on that specific card.

If desired when the game instructs the player to tell the truth, the players can require the player telling the truth to place their thumb (or any other finger) on the “lie detector” button. If the game determines the player is telling the truth, the player is awarded. If the game determines the player is telling a lie, the player is not awarded.

Please note that if the game selects double dare and there are double dares recorded, no category will be displayed. A prerecorded double dare will be randomly selected and played through the speaker. The player who has been chosen must now perform this double dare.

Each step of game play described above is optional and any step may be skipped or ignored during any phase of play. Furthermore, additional steps can be inserted and the game instructions and steps can be performed in any suitable order. The above described steps are merely exemplary and preferred.

While a particular embodiment has been chosen to illustrate the invention, it will be understood by those skilled in the art that various changes and modifications can be made therein without departing from the scope of the invention as defined in the appended claims.

The invention is claimed as follows:

1. An electronic game, comprising:
a base;
a spinning unit affixed to said base and adapted to spin relative thereto, said spinning unit including a display mechanism adapted to displaying text that dictates actions to be taken in said electronic game;
a circuit for controlling said display mechanism; and
a sensor including a magnet disposed in said base and a magnetic switch disposed in said spinning unit for communicating with said circuit,
whereby said circuit triggers said display mechanism based on the communications from the sensor independent of a minimum speed requirement.

2. An electronic game according to claim 1, wherein
said display mechanism includes light emitting diodes.

3. An electronic game according to claim 1, wherein
said spinning unit includes a speaker.

4. An electronic game according to claim 3, wherein
said spinning unit includes a microphone for recording sounds to be played by said speaker.

5. An electronic game according to claim 1, wherein
said spinning unit includes a handle.

6. An electronic game according to claim 5, wherein
said handle includes at least one control button.

7. An electronic game according to claim 1, wherein
said spinning unit is translucent plastic.

8. An electronic game according to claim 1, wherein
said circuit is disposed in said spinning unit.

9. An electronic game according to claim 1, wherein
said circuit is a microprocessor.

10. An electronic game according to claim 1, wherein
said display mechanism is a single row of light emitting diodes.

11. An electronic game according to claim 1, wherein
said single row of light emitting diodes extends from an outer periphery of the spinning unit towards the center of the spinning unit.

12. An electronic game according to claim 11, wherein
said single row includes seven light emitting diodes.

13. An electronic game according to claim 11, wherein
said spinning unit is substantially circular and said single row extends along a radial line thereof.

14. An electronic game, comprising
a base;
a spinning body adjacent said base and adapted to rotate relative thereto;
a display mechanism disposed on said spinning body and adapted to display a text message when said spinning body is rotating; and
a circuit in electrical communication with said display mechanism and adapted to communicate the text to be displayed; and
a sensor including a magnet and a magnetic switch in electrical communication with said circuit, and adapted to communicate to said circuit when said spinning body is rotating, thereby effecting initiation of the text display.

15. An electronic game according to claim 14, wherein
said sensor is configured such that is can determine the rotational speed at which the spinning body is rotating, thereby effecting regulation of the text display.

16. An electronic game according to claim 14, wherein
said spinning body is coupled to said base.

17. An electronic game according to claim 16, wherein
said spinning body is substantially surrounded by said base.

18. An electronic game according to claim 14, wherein
said magnet is disposed in said base; and
said magnetic switch is disposed in said spinning body.

19. An electronic game according to claim 14, wherein
said display mechanism includes light emitting diodes.

20. An electronic game according to claim 14, wherein
said spinning body includes a speaker.

21. An electronic game according to claim 20, wherein
said spinning body includes a microphone for recording sounds to be played by said speaker.

22. An electronic game according to claim 14, wherein
said display mechanism is a single row of light emitting diodes.

23. An electronic game according to claim 22, wherein
said single row of light emitting diodes extends from an outer periphery of the spinning body towards the center of the spinning body.

24. An electronic game according to claim 23, wherein
said single row includes seven light emitting diodes.

25. An electronic game according to claim 23, wherein
said spinning body is substantially circular and said single row extends along a radial line thereof.

26. An electronic game according to claim 14, wherein
said spinning body includes a handle.

27. An electronic game according to claim 26, wherein
said handle includes at least one control button.

28. A method of displaying text for an electronic gaming device, the gaming device having a spinning unit and a base, the method comprising the steps of
rotating the spinning unit relative to the base;
using a sensor to generate information by determining when the spinning unit makes a complete revolution, and the rate at which the spinning unit revolves; and
initiating a text display based on the information from the sensor.

29. A method according to claim 28, wherein
the step of using a sensor includes using a magnet and a magnetic switch.

30. A method according to claim 28, wherein
the step of initiating a text display includes text formed from a single row of light emitting diodes.

31. A method according to claim 30, wherein
the spinning unit is substantially circular; and
the single row of light emitting diodes extends along a radial line of said spinning unit.

32. A method according to claim 28, further including the step of
regulating the text display using the information from the sensor.

33. A method according to claim 32, wherein
the regulating step includes regulating the text display using the rate at which the spinning unit revolves.

34. A method of playing an electronic game with a spinning electronic display, comprising the steps of
spinning a body that is coupled to a base, the body including at least two lights positioned thereon;
activating a magnetic sensor that determines if the body is spinning relative to the base;
reading a text display formed by the lights positioned on the spinning body being selectively activated when the sensor indicates that the body is spinning; and
taking action dependent upon the text display.
